(19) United States
(12) Patent Application Publication
(10) Pub. No.: US 2026/0195436 A1
(43) Pub. Date: Jul. 9, 2026

(54) AUTHENTICATION FOR DEVICE SECURITY

(71) Applicant: British Telecommunications Public Limited Company, London Greater London (GB)

(72) Inventors: Jonathan ROSCOE, London Greater London (GB); Max SMITH-CREASEY, London Greater London (GB)

(21) Appl. No.: 19/133,674

(22) PCT Filed: Oct. 3, 2023
(86) PCT No.: PCT/EP2023/077331

§ 371 Date: May 28, 2025

(30) Foreign Application Priority Data
Nov. 30, 2022 (EP) 22210608.0

(51) Int. Cl. G06F 21/32

(52) U.S. Cl. CPC G06F 21/32

(57) ABSTRACT

A method of authenticating a user of a computing device is described. Event data is received from a sensor of the computing device sensing a gesture of a person with respect to a keyboard. An image is generated from the event data, the image representing the keyboard and the event data. The image is classified using a classifier that has been trained using training data; or the image is compared with a reference image created from the training data; and in response to the classifying or the comparing, authenticating the user of the computing device. The training data comprises historical images representing both the region and historical instances of the event data. The historical images have been aligned using a joint alignment process.

The present disclosure relates to authentication for device security, such as for authenticating a user of a computing device.

### BACKGROUND

Device security is an ongoing concern for smart phones, laptops, smart watches and other types of computing device. Where an unauthorised user gains access to a computing device they potentially gain access to secure functionality and secure material on the computing device itself, or accessible via the computing device such as via a communications network. Especially where computing devices are portable the risk of access to those computing devices via unauthorised users increases since the computing devices may be used on public transport, in public venues and at other locations which are not secure.

Authentication is a process whereby an entity is verified as having a stated or claimed identity. The entity is sometimes a computing entity and sometimes a person. Various approaches to authentication have been developed such as those using biometrics, passwords, communications network addresses and others.

The examples described herein are not limited to examples which solve problems mentioned in this background section.

### SUMMARY

Examples of preferred aspects and embodiments of the invention are as set out in the accompanying independent and dependent claims.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In a first aspect of the disclosed technology there is a method of authenticating a user of a computing device, the method comprising:
receiving event data from a sensor of the computing device sensing a gesture of a person with respect to a region;
generating an image from the event data, the image representing the keyboard and the event data;
classifying the image using a classifier that has been trained using training data; or comparing the image with a reference image created from the training data; and
in response to the classifying or the comparing, authenticating the user of the computing device;
wherein the training data comprises historical images representing the region and historical instances of the event data, and wherein the historical images have been aligned using a joint alignment process. By classifying an image which represents the region and the event data, an accurate, efficient way of authenticating the user is given. Using an image is found to be an effective way to represent both the region and the event data in a concise way. With this representation classification is both efficient and accurate. Since the training data comprises historical images that have been aligned using a joint alignment process, the authentication process has improved accuracy. In some cases the region is a keyboard. In some cases the region is an image and a user applies gesture to familiar points in the image in order to input text to a computing device. Thus a region is all or part of the input area of a touch screen device; or all or part of a mixed-reality or virtual reality user interface.

In some examples, the gesture is for inputting a word or passcode into the computing device (such as by swipe typing). Where the user is entering text into the computing device anyway, the user does not have to interrupt his or her current task in order to complete an authentication process.

In some examples, prior to classifying the image, the image is aligned with the historical images using the joint alignment process. This enables variation due to different keyboards or other regions to be allowed for and so improves accuracy of authentication.

In some examples, the event data comprises a series of 2D coordinates and optionally one or more of: velocity, pressure, dwell time, stylus button press events, area, points of redirection, finger stability (straightness of lines), starting nodes, end nodes, direction. Representing such 2D coordinates in the form of an image enables image processing techniques to be used. Using different types of event data is found to improve accuracy of the user authentication process.

In some examples, the historical images represent a gesture that has been made multiple times by the user. In this way, natural variation in the gesture of the user are captured. The variation arises because of different times of day and conditions when the user makes the gesture (in the dark versus in daylight, or when tired). The variation also arises because of different resolutions of region over which the user makes the gesture. The region may be a keyboard such as a physical or graphical keyboard. The region may be an image such as a photograph where the user touches familiar points in order to enter a passcode. The variation in the user gesture captured in the historical images is difficult for a malicious party to spoof and so by capturing this variation security is enhanced.

In some examples, the historical images represent a gesture that has been made by a plurality of different users. In this way, variation amongst a population of users is captured. Variation of a gesture amongst a population of users is difficult for malicious parties to spoof.

In some examples, the historical images represent a gesture that has been made over regions of different resolution. By capturing variability for regions of different resolution the authentication is made more robust; that is, the authentication works for a range of different keyboard resolutions or image resolutions (where the user authenticates by touching familiar locations of a photograph or other image).

In some examples, the joint alignment comprises modifying the historical images using any of: rotation, shear, translation, scale; in order to reduce an entropy of the historical images. In this way the historical images become similar (since outlier features are ameliorated) and yet still capture information about variation between gestures which is to be expected. Since influence of outlier features is ameliorated the authentication process becomes more accurate.

In some examples, the entropy of the historical images is computed by stacking the historical images and, for each pixel in one of the historical images, computing an entropy over that pixel and the corresponding pixel in the other stacked images. This gives an efficient yet accurate way to compute entropy since the entropy of individual pixels may be computed in parallel.

In some examples, the reference image is a heat map comprising a 2D array of pixels, each pixel storing an intensity value representing a probability that the gesture should cover it. Using a heat map is a concise and powerful representation which enables accurate, efficient authentication.

In some examples, the heat map is formed by aggregating the historical images and optionally scaling the intensity values to be between zero and one. Aggregation, such as by addition, is efficient to compute. Scaling the intensity values enables biases to be removed, such as where there is a difference in size of populations used to create heat maps. By normalising to between zero and one, float values are obtained which give efficiencies in matrix manipulation and facilitate efficiency of the joint alignment.

In some examples, comparing the image with the reference image comprises subtracting the image, in the form of a heat map, from the reference image, in the form of a heat map, to obtain a difference and comparing the difference with a threshold. Using subtraction is efficient and yet gives accurate authentication.

In some examples, the method involves determining that the gesture of the user is for inputting a specified word or passcode into the computing device, and where the reference image is for the specified word or passcode. Thus a direct comparison facilitates authentication and is efficient to compute.

In some examples, the method comprises comparing a heat map of a specified word for the user with a heat map of the same word for a second user, and determining whether gesture typing is an effective mechanism for the second user based on the comparison. This gives a practical way to assess whether gesture typing will be useful for authenticating a particular user or not.

In another aspect there is a computer program comprising instructions which when executed on a computing device implement the method described above.

In another aspect there is a computing device comprising:

a processor; a sensor for sensing a gesture; a memory storing instructions that, when executed by the processor, perform a method for authenticating a user of a computing device, the method comprising:

receiving event data from a sensor of the computing device sensing a gesture of the user with respect to a region;

generating an image from the event data, the image representing the region and the event data;

classifying the image using a classifier that has been trained using training data; or comparing the image with a reference image created from the training data; and

in response to the classifying or the comparing, authenticating the user of the computing device;

wherein the training data comprises historical images representing the region and historical instances of the event data, and wherein the historical images have been aligned using a joint alignment process.

It will also be apparent to anyone of ordinary skill in the art, that some of the preferred features indicated above as preferable in the context of one of the aspects of the disclosed technology indicated may replace one or more preferred features of other ones of the preferred aspects of the disclosed technology. Such apparent combinations are not explicitly listed above under each such possible additional aspect for the sake of conciseness.

Other examples will become apparent from the following detailed description, which, when taken in conjunction with the drawings, illustrate by way of example the principles of the disclosed technology.

### BRIEF DESCRIPTION OF THE DRAWINGS

FIG. 1 is a schematic diagram of a computing device with an authentication component;

FIG. 2 shows a keyboard with a gesture, an image representing event data, and part of a heat map;

FIG. 3 is a flow diagram of a method of training a classifier or a reference image, for use with an authentication component;

FIG. 4 is a schematic diagram of part of an image and of a stack of images;

FIG. 5 is a flow diagram of a method performed by an authentication component;

FIG. 6 is a schematic diagram of a computing device with an authentication component.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is made for the purpose of illustrating the general principles of the present technology and is not meant to limit the inventive concepts claimed herein. As will be apparent to anyone of ordinary skill in the art, one or more or all of the particular features described herein in the context of one embodiment are also present in some other embodiment(s) and/or can be used in combination with other described features in various possible combinations and permutations in some other embodiment(s).

There is an ongoing need for efficient and accurate ways to authenticate users of computing devices. As the amount of functionality and data accessible via computing devices such as smart phones increases the need for efficient, accurate authentication becomes more acute.

Previous approaches to authentication are complex, such as two factor authentication processes, and often involve a user having to interrupt their current task in order to carry out authentication.

The inventors have developed an accurate, efficient way of authenticating a user from gesture typing. Gesture typing is a way for users to type on their keyboards by swiping their fingers across the letters that they wish to use to construct the word. It is started when the finger touches the screen and finishes when the finger is removed from the screen.

The inventors have recognized that the way users type has been shown to be unique to them. This is because the formation of word gestures are a series of touch events, each touch event is a point within the word gesture (with x and y coordinates), from which user-level features can be extracted. These touch events are stored alongside a timestamp, and possibly pressure and area information that also yields identifying properties. The touch points are not obtained after fixed time periods, they are more frequent when a user moves their finger.

Features extracted from gesture typing include pause and redirect events, when the finger hits a letter, pauses, and redirects to another letter. The inventors have recognized these events are good features for user identification. The inventors have developed a way of representing or encoding such features in an image so that authentication can be carried out accurately and efficiently.

The inventors have recognized that the way a user types a particular word or passcode varies between instances of typing the word or passcode. Variation might be for a number of reasons such as how tired the user is, what resolution the region is over in which the user is making the gesture (such as the resolution of a graphical keyboard or the size of a physical keyboard), what level of ambient light there is, whether the user is wearing their spectacles or not and other factors. By capturing information about the natural variation in a user's gesture for a particular word or passcode it is found to be possible to improve accuracy of authentication. Capturing variation in a gesture for inputting a particular word or passcode over a population of users is also useful to improve accuracy of authentication.

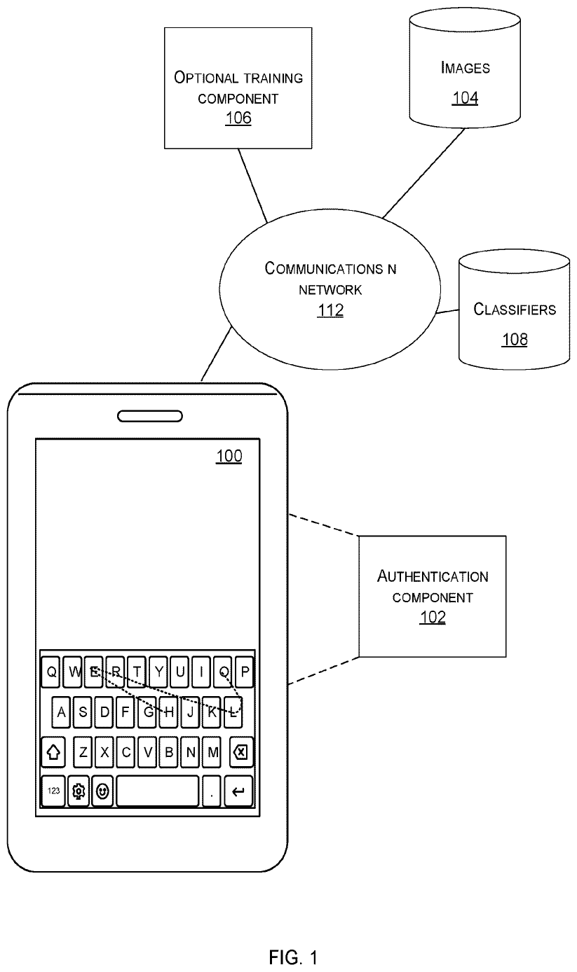

FIG. 1 is a schematic diagram of a computing device 100 with an authentication component 102 for authenticating a user of the computing device 100. In the example of FIG. 1 the computing device 100 is a smart phone although other types of computing device are also usable with the present technology. A non-exhaustive list of example computing devices is: smart phone, tablet computer, laptop computer, smart watch. The computing device has an authentication component 102 deployed in the computing device using any of: software, firmware, hardware.

The authentication component receives event data from a sensor of the computing device sensing a gesture of a person with respect to a region. In an example the region is a keyboard or image which is part of a graphical user interface displayed on a touch screen of the computing device 100. In another example the region is part of a graphical user interface displayed using a mixed reality computing device. In some cases the region is a physical keyboard and the sensor senses activation of physical keys of the physical keyboard. The sensor is any sensor for sensing a gesture of a person with respect to a region. In an example the sensor is a touch sensitive screen of the computing device. In another example the sensor is an image capture device.

The authentication component generates an image from the event data. The authentication component processes the image either itself or by sending the image (optionally after compressing and/or encrypting the image) to a processor 108 at a remote computing entity in communication with the computing device 100 via a communications network 112. The processor at the remote computing entity classifies the image and/or compares the image with a reference image. The processor sends back the classification and/or comparison outcome to the computing device 100 via communications network 112.

In cases where the authentication component 102 processes the image itself, functionality for classifying and/or comparing an image with a reference image is deployed at the computing device.

Thus the functionality of the authentication component 102 may be shared between the computing device 100 and one or more other computing entities via communications network 112. Communications network 112 is any communications network such as the internet, an intranet, or any other communications network.

The computing device 100 optionally has access to images 104 which are images of regions such as keyboards with or without event data. The computing device 100 optionally has access to a training component 106 for training a classifier for use with the authentication component 102 and/or for creating a reference image from training examples.

The authentication component has functionality to trigger a lock to lock the computing device depending on an outcome of classification of an image and/or an outcome of comparing the image with a reference image. In some cases the authentication component has functionality to unlock the computing device depending on the outcome of classification of an image and/or the outcome of comparing the image with a reference image.

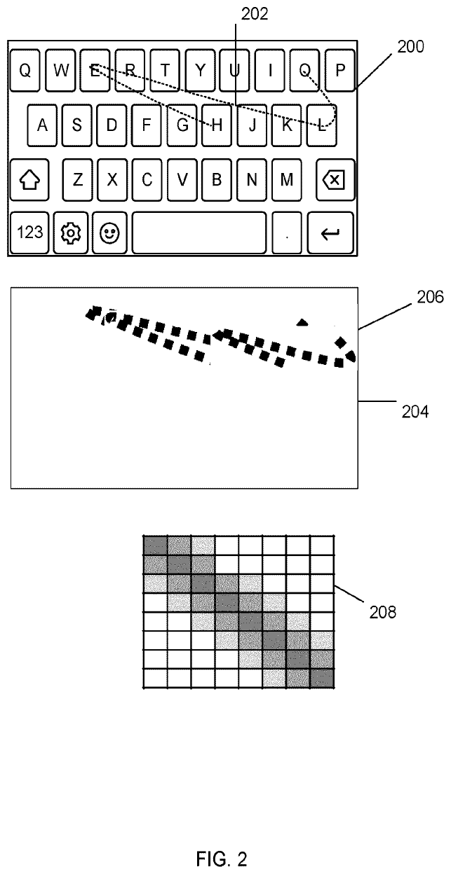

FIG. 2 shows a keyboard 200 with a gesture 202, an image 204 with a plurality of gestures 206, and part of a heat map 208. The top part of FIG. 2 shows a keyboard 200 which may be a physical keyboard or a keyboard displayed as part of a graphical user interface. The keyboard is associated with a computing device such as computing device 100 of FIG. 1. In an example, the keyboard is associated with the computing device because it is a physical keyboard connected to the computing device using a wireless or wired connection. In another example, the keyboard is associated with the computing device because it is part of a graphical user interface of the computing device. A user has made a gesture 202 over the keyboard and in the example of FIG. 2 the gesture is a continuous swipe over the keyboard starting from “H” key, travelling to the “E” key, travelling to the “L” key and terminating at the “O” key. In this example the user is typing the word “Hello” on the keyboard. However, this is one example only and the user may input other words, parts of words, passcodes, passwords or other data using the keyboard 200. In examples the gesture is a continuous gesture and has a start and an end. The gesture is made by a user's digit (finger or thumb) or using a stylus.

Whilst a user made the gesture 202, event data was received at the authentication component 102 from a sensor of the computing device 100. In an example the event data comprises a series of 2D coordinates along a path of the gesture. Optionally the event data also comprises one or more of: velocity, area, pressure, dwell time, stylus button press events.

In some examples, the authentication component 102 generates image 204 from the event data by converting the event data into graphical data and adding the graphical data to an image representing the keyboard. In the example in the middle of FIG. 2 the event data is in graphical form and comprises dotted lines. The event data in graphical form is added to an image representing the keyboard, which in this example is a rectangle having a resolution (height and width) which is proportional to a resolution of the keyboard 200. The image in the middle of FIG. 2 shows several sets of event data, one per gesture instance for inputting the same word or passcode. In some cases the image in the middle of FIG. 2 is a multi channel image, with one channel storing the 2D coordinates of the event data and each other channel storing a different type of event data such as velocity, area, pressure, dwell time, stylus button press events.

In various examples, the reference image is a heat map as now explained.

In the example at the bottom of FIG. 2 there is part of a heat map 208. The heat map 208 is a 2D array where each cell of the array holds a numerical value which is an intensity value representing a probability that the gesture should cover it. The heat map is formed by aggregating the historical images and optionally scaling the intensity values to be between zero and one. In the example of FIG. 2 the heat map is formed by adding a plurality of images, one image for each of the gestures 206. In FIG. 2 the part of the heat map 208 has high intensity values along a diagonal of the 2D array and intensity values which taper to zero with distance from the diagonal.

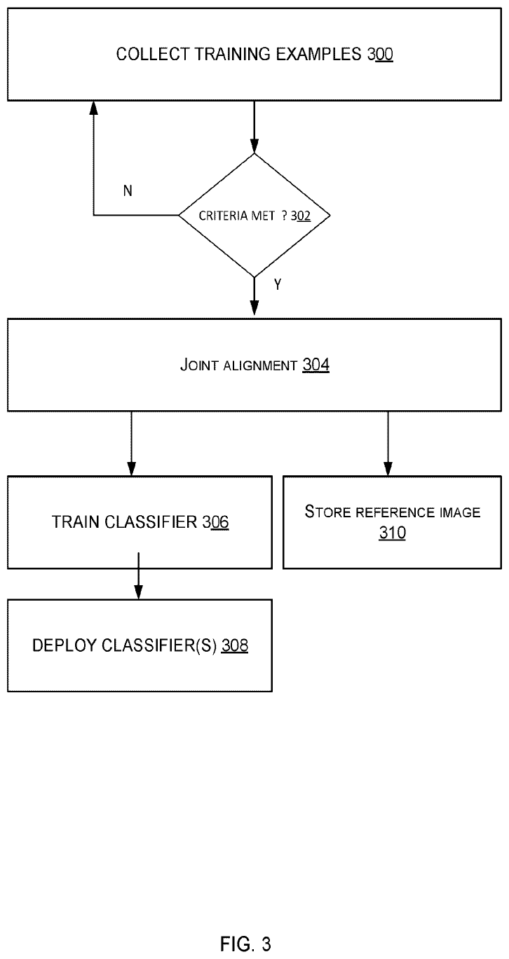

FIG. 3 is a flow diagram of a method of training a classifier or computing a reference image for use with an authentication component such as the authentication component of FIG. 1. The method of FIG. 3 may be performed by training component 106 of FIG. 1.

Where the process of FIG. 3 uses a classifier, the classifier is a machine learning model. A non-exhaustive list of examples of machine learning model suitable for use with the method of FIG. 3 is: support vector machine, random decision forest, neural network. The machine learning model is trained using supervised learning using a plurality of training examples.

The process of FIG. 3 uses training examples. In an example, the training examples are images generated from past event data known to have resulted from gestures of a specified user. Thus, in this example, the process of FIG. 3 produces one or both of: a trained classifier which is bespoke to a particular user, or a reference image which is bespoke to the particular user.

Training examples are collected 300 by recording event data for a plurality of users making gestures over a region of a computing device such as a keyboard or other region. The event data is converted to image form so that the training examples may be referred to as historical images. The event data comprises 2D coordinates along a path of the gesture and optionally one or more of: velocity, pressure, dwell time, area, stylus button press events, acceleration, speed, points of redirection, finger stability (straightness of lines), starting nodes, end nodes, direction. For each user it is known whether the user is the particular authorised user or not. Thus, each training example is event data of a gesture (in the form of an image) and a label indicating authorised or not authorised. The event data and labels are sent from the computing device to a remote computing entity for doing the training such as training component 106 of FIG. 1.

If criteria are met at decision 302 the training component 106 proceeds to compute a joint alignment of the training examples. If the criteria are not met the training component 106 continues to collect training examples. In an example, the criteria are rules or a threshold such as a threshold number of training examples.

Computing the joint alignment comprises modifying the historical images using any of: rotation, shear, translation, scale; in order to reduce an entropy of the historical images. In this way outlier features in the historical images are minimized without impacting other features of the historical images which are useful for authentication.

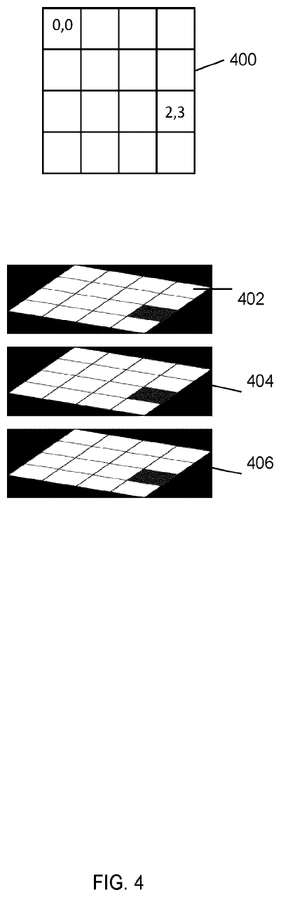

In various examples, the entropy of the historical images is computed by stacking the historical images and, for each pixel in one of the historical images, computing an entropy over that pixel and the corresponding pixel in the other stacked images. More detail about how the stacking is done is given later with reference to FIG. 4.

In an example, the joint alignment process comprises the following steps:
1. Access the training examples (see operation 300 of FIG. 3) so as to obtain multiple samples of a user's chosen gesture, as a plurality of images
2. For each image In, create a transformation matrix, based on identity Ti:
3. Stack the images. Compute pixel-wise entropies for the stack of images as described in more detail below with reference to FIG. 4.
4. For each of a plurality of affine parameters of each image (rotation, shear, translate, scale), and for dimensions x and y of the image carry out the following sequence of operations:
4.1. Create a transformation matrix with a nominal (e.g. 1 pixel) value as X
4.2. Apply X to image I
4.3. Calculate pixelwise entropy
5. If entropy has decreased, retain X as Ti:
6. If entropy has not decreased, X=the inverse square of X
6.1. Apply the new X (X−1) to I
6.2. Calculate pixelwise entropy
6.3. If entropy decreased, retain X as Ti:
7. Calculate the current mean image M as an average of the images
8. Repeat sets 3-7 until convergence is reached. Convergence is reached after a specified time or after a specified number of repetitions or according to other criteria.
9. Apply each transform Ti to In giving a plurality of aligned images, referred to as aligned image set A. Store aligned image set A.
10. Optionally, M is stored 310 as the reference image for gesture

The process of FIG. 3 optionally comprises training 306 a classifier which is a machine learning classifier. The classifier is trained using supervised learning and the labelled training examples (i.e. the historical images). Any suitable supervised learning algorithm is used. Once the classifier is trained it is deployed 308 at the authentication component 102 such as by parameters of the classifier being sent to the computing device and configured in a classifier at the computing device.

In an example the trained classifier is only operable to classify a single specific word. In this case the training examples are examples of event data for the specific word. The training component may train a plurality of classifiers, each classifier operating for a different word.

In some cases the classifier is pre-trained using examples from a population of different users prior to the process of FIG. 3. In this case the process of FIG. 3 personalizes the classifier for use by a particular user.

In some examples the classifier is a convolutional neural network. The authentication component is found to be particularly effective when the classifier is a neural network, both in terms of accuracy and efficiency.

The process of FIG. 3 optionally comprises computing and storing 310 a reference image. In some examples, the reference image is a heat map comprising a 2D array of pixels, each pixel storing an intensity value representing a probability that the gesture should cover it. The heat map is formed by aggregating the historical images and optionally scaling the intensity values to be between zero and one. Aggregating the historical images is efficient to compute and any suitable aggregation is used. A non-exhaustive list of possible aggregation methods which are used is: addition, multiplication, weighted sum, average, median, mode. In a preferred example, the aggregation is an average and is found to be efficient to compute and accurate in practice. The reference image is stored at any computing entity accessible to the authentication component 102.

FIG. 4 shows an example of part 400 of an image such as a historical image from training examples collected at operation 300 of FIG. 3. The part 400 of the image is a 2D array which in this case is a 4 by 4 grid. Numerical values in the pixels of the grid are intensity values and are not shown in FIG. 4. One of the pixels in the 4 by 4 grid is marked as the origin denoted (0,0) and another of the pixels in the 4 by 4 grid is marked (2, 3) as being the cell with coordinates x=2, y=3. FIG. 4 also shows a stack of images 402, 404, 406 such as a stack of historical images from training examples collected at operation 300 of FIG. 3. The images are stacked by being placed one above the other so that an origin (0,0) of each image is in registration with the origins of the other images. The images may be much larger than those indicated in FIG. 4. The images are logically stacked within the computer, so that the joint alignment process is able to efficiently read a value from a pixel in a first one of the images and a value from a corresponding pixel in each of the other stacked images.

Once the images are stacked, entropy is computed for a stack of pixels within the stack of images as follows:

$$H ( X ) = - {\sum }_{i = 1}^{n} P ( {x}_{i} ) log P ( {x}_{i} ) .$$

Which is expressed in words as the entropy of pixel stack X is equal to the negative sum over the possible values of a pixel of the probability of the pixel having value i times the logarithm of the probability of the pixel having value i.

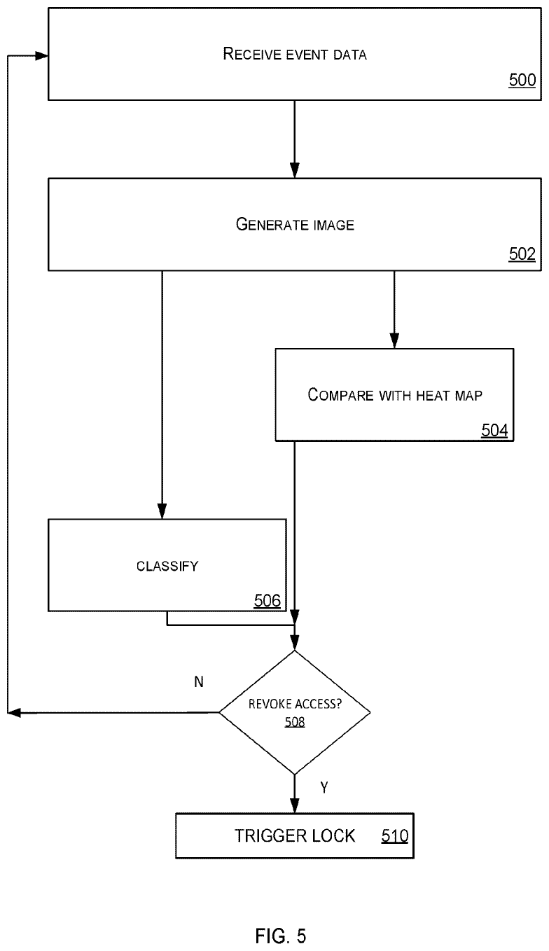

FIG. 5 is a flow diagram of a method of operation of an authentication component such as that of FIG. 1. The authentication component receives 300 event data from a sensor of the computing device sensing a gesture of a person with respect to a region. In an example, a person is making a swipe gesture over a keyboard or image in order to input a word, a passcode or other text. In an example the sensor is an image capture device capturing images of the person making the gesture with respect to the region. In another example the sensor is a touch screen of the computing device. In examples the event data comprises a series of 2D coordinates along a path of the gesture.

The authentication component generates 502 an image representing the region. The image preferably has a resolution related to the resolution of the region. In some cases the resolution of the region (keyboard or image) is obtained from the computing device and used to generate the image of the region.

The authentication converts the received event data into an image representation and adds it to the image representing the region. In an example, generating the image from the event data comprises converting the event data into graphical data and adding the graphical data to an image representing the region such as a 2D array with a resolution (height and width) related to a resolution of the region (keyboard or other image). The 2D array may be populated with numerical values set to a default.

The result of operation 502 is an output image representing the region and having event data encoded in the image.

In some cases, the output image is aligned with the historical images of the FIG. 3 process. The alignment may be a joint alignment process as explained above with reference to FIG. 3. The aligned output image is then classified as now explained. By aligning the output image with the historical images it is possible to correct for variation that may occur due to different regions, such as different keyboards or other input regions.

The output image is optionally classified 506 by the authentication component. The authentication component may use a classifier within the authentication component or at a remote computing entity as explained with reference to FIG. 1. The classifier optionally classifies 506 the image into either a class authenticating the user or another class which does not authenticate the user. In response to the image being classified into the class authenticating the user, the authentication component enables the computing device to operate in an unlocked state and the method of FIG. 5 returns to operation 500. In the case that the computing device was locked prior to the method of FIG. 5 being performed the action at decision point 508 to not revoke access causes the computing device to be unlocked. In the case that the computing device was unlocked prior to the method of FIG. 5 being performed the action at decision point 508 to not revoke access causes the computing device to continue in an unlocked state.

At decision point 508, if the authentication outcome does not authenticate the user, the authentication component triggers 510 a lock to lock the computing device. Therefore the computing device either continues in a locked state (if it was locked prior to the method of FIG. 5) or becomes locked (if it was unlocked prior to the method of FIG. 5). In order to trigger the lock the authentication component sends an instruction to an operating system of the computing device which causes the operating system to lock the computing device such that the full functionality of the computing device is not accessible to the person who made the gesture.

Once the image has been generated at operation 502, the authentication component optionally compares the generated image representing the event data with a reference image. The reference image is a reference image such as that generated in operation 310 of FIG. 3. In an example the reference image is a heat map. The reference image is accessible by the authentication component.

The authentication component compares 504 the generated image and the reference image, such as by computing a difference between the images by subtracting one from the other to obtain a difference. If the difference is more than a threshold amount the authentication component makes a decision at decision point 508 to revoke access. Where heat maps are used the generated image and the reference image are both heat maps. Subtracting heat maps is efficient to compute and gives a numerical score which can be assessed against a threshold. Where access is revoked a lock is triggered 510 as described above. If the difference is less than a threshold amount the authentication component makes a decision at decision point 508 not to revoke access. Thus the computing device is unlocked if it was previously locked, or is continued in an unlocked state.

In some examples, operation 504 of FIG. 5 comprises comparing the image with the reference image by subtracting the image, in the form of a heat map, from the reference image, in the form of a heat map, to obtain a difference and comparing the difference with a threshold.

In some cases, the method of FIG. 5 comprises determining that the gesture of the user is for inputting a specified word or passcode into the computing device, and where the reference image is for the specified word or passcode.

In some examples, the method of FIG. 5 is extended to comprise comparing a heat map of a specified word for the user with a heat map of the same word for a second user; and determining whether gesture typing is an effective mechanism for the second user based on the comparison

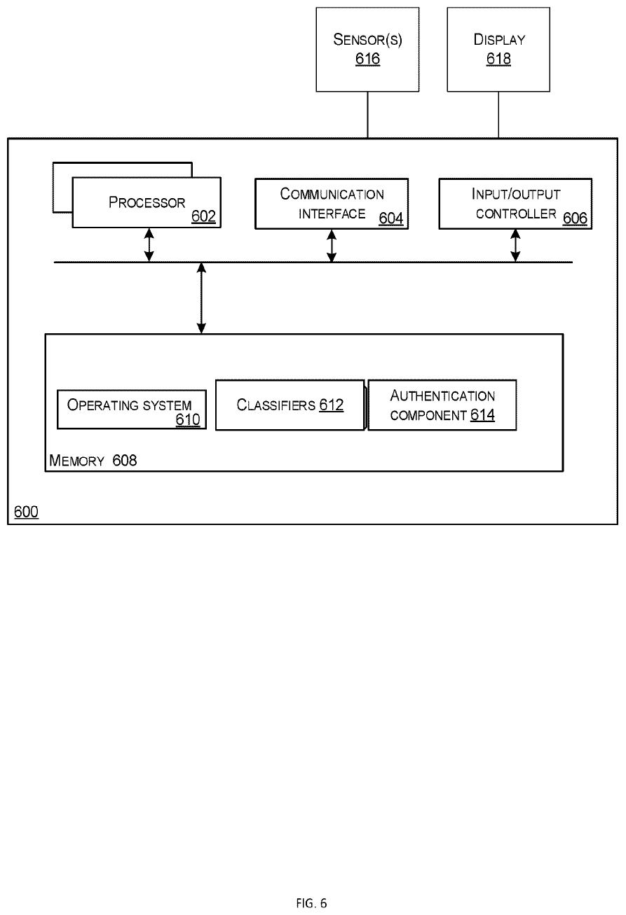

FIG. 6 illustrates various components of an example computing device 600 in which embodiments of authentication functionality are implemented in some examples. The computing device is of any suitable form such as a smart phone, a tablet computer, a laptop computer, a smart watch, a wearable computer.

The computing device 600 comprises one or more processors 602 which are microprocessors, controllers or any other suitable type of processors for processing computer executable instructions to control the operation of the device in order to perform the methods of FIGS. 3 to 5. In some examples, for example where a system on a chip architecture is used, the processors 602 include one or more fixed function blocks (also referred to as accelerators) which implement a part of the method of FIGS. 3 to 5 in hardware (rather than software or firmware). That is, the methods described herein are implemented in any one or more of software, firmware, hardware. The computing device optionally has one or more classifiers 612 for classifying images into classes which authenticate a user or do not authenticate a user. The computing device has an authentication component 614 for authenticating a user as described herein. Platform software comprising an operating system 610 or any other suitable platform software is provided at the computing-based device to enable application software to be executed on the device such as for displaying a keyboard using graphics such as at a touch screen display of the computing device or other type of display device 618. Although the computer storage media (memory 608) is shown within the computing-based device 600 it will be appreciated that the storage is, in some examples, distributed or located remotely and accessed via a network or other communication link (e.g. using communication interface 604).

The computing-based device 608 also comprises an input/output controller 606 arranged to output display information to display device 618 which may be separate from or integral to the computing-based device 600. The display information may provide a graphical user interface. The input/output controller 606 is also arranged to receive and process input from one or more devices, such as one or more sensors 616 for capturing gestures. The one or more sensors are any of: a touch screen, a camera, a capacitive touch panel. The input-output controller 606 is able to receive and process input from a user input device (e.g. a mouse, keyboard, camera, microphone or other sensor). In some examples the user input device 606 detects voice input, user gestures or other user actions. In an embodiment the display device 618 also acts as the user input device if it is a touch sensitive display device. The input/output controller 606 outputs data to devices other than the display device 618 in some examples.

Any reference to ‘an’ item refers to one or more of those items. The term ‘comprising’ is used herein to mean including the method blocks or elements identified, but that such blocks or elements do not comprise an exclusive list and an apparatus may contain additional blocks or elements and a method may contain additional operations or elements. Furthermore, the blocks, elements and operations are themselves not impliedly closed.

The steps of the methods described herein may be carried out in any suitable order, or simultaneously where appropriate. The arrows between boxes in the figures show one example sequence of method steps but are not intended to exclude other sequences or the performance of multiple steps in parallel. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

Where the description has explicitly disclosed in isolation some individual features, any apparent combination of two or more such features is considered also to be disclosed, to the extent that such features or combinations are apparent and capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

1. A method of authenticating a user of a computing device, the method comprising:
receiving event data from a sensor of the computing device sensing a gesture of the user with respect to a region;
generating an image from the event data, the image representing the region and the event data;
classifying the image using a classifier that has been trained using training data; or
comparing the image with a reference image created from the training data; and
in response to the classifying or the comparing, authenticating the user of the computing device;
wherein the training data comprises historical images representing the region and historical instances of the event data, and wherein the historical images have been aligned using a joint alignment process.

2. The method as claimed in claim 1, comprising prior to classifying the image, aligning the image with the historical images using the joint alignment process.

3. The method as claimed in claim 1, wherein the event data comprises a series of 2D coordinates and optionally one or more of: velocity, pressure, dwell time, area, stylus button press events, acceleration, speed, points of redirection, finger stability, starting nodes, end nodes, direction.

4. The method as claimed in claim 1, wherein the historical images represent a gesture that has been made multiple times by the user.

5. The method as claimed in claim 1 wherein the historical images represent a gesture that has been made by a plurality of different users.

6. The method as claimed in claim 1 wherein the historical images represent a gesture that has been made over regions of different resolution.

7. The method as claimed in claim 1 wherein the joint alignment comprises modifying the historical images using any of: rotation, shear, translation, scale; in order to reduce an entropy of the historical images.

8. The method as claimed in claim 7 wherein the entropy of the historical images is computed by stacking the historical images and, for each pixel in one of the historical images, computing an entropy over that pixel and the corresponding pixel in the other stacked images.

9. The method as claimed in claim 1 wherein the reference image is a heat map comprising a 2D array of pixels, each pixel storing an intensity value representing a probability that the gesture should cover it.

10. The method as claimed in claim 8 wherein the heat map is formed by aggregating the historical images and optionally scaling the intensity values to be between zero and one.

11. The method as claimed in claim 1 wherein comparing the image with the reference image comprises subtracting the image, in the form of a heat map, from the reference image, in the form of a heat map, to obtain a difference and comparing the difference with a threshold.

12. The method as claimed in claim 1 comprising determining that the gesture of the user is for inputting a specified word or passcode into the computing device, and where the reference image is for the specified word or passcode.

13. The method as claimed in claim 1 comprising comparing a heat map of a specified word for the user with a heat map of the same word for a second user; and determining whether gesture typing is an effective mechanism for the second user based on the comparison.

14. A computer program comprising instructions which when executed on a computing device implement the method of claim 1.

15. A computing device comprising:
a processor;
a sensor for sensing a gesture;
a memory storing instructions that, when executed by the processor, perform a method for authenticating a user of a computing device, the method comprising:
receiving event data from a sensor of the computing device sensing a gesture of the user with respect to a region;
generating an image from the event data, the image representing the region and the event data;
classifying the image using a classifier that has been trained using training data; or
comparing the image with a reference image created from the training data; and
in response to the classifying or the comparing, authenticating the user of the computing device;
wherein the training data comprises historical images representing the region and historical instances of the event data, and wherein the historical images have been aligned using a joint alignment process.
